(19) United States
(12) Patent Application Publication
(10) Pub. No.: US 2008/0055029 A1
(43) Pub. Date: Mar. 6, 2008

(54) METHOD FOR MANUFACTURING STATOR, AND MAGNETIZING CORE

(76) Inventors: Tomohiro Aoyama, Kosai-shi (JP); Yasuhide Ito, Hamamatsu-shi (JP)

Correspondence Address: PEARL COHEN ZEDEK LATZER, LLP, 1500 BROADWAY 12TH FLOOR, NEW YORK, NY, 10036, US

(21) Appl. No.: 11/849,694

(22) Filed: Sep. 4, 2007

(30) Foreign Application Priority Data
Sep. 6, 2006 (JP) 2006-241670

(51) Int. Cl. H02K 15/02; H01F 13/00; H01F 3/00

(52) U.S. Cl. 335/284; 29/596

(57) ABSTRACT

Ferromagnetic bodies, the number of which is n (n is an integer greater than or equal to two), are secured to an inner circumferential surface of a cylindrical yoke. A first gap S1 is provided between ferromagnetic bodies that are adjacent to each other in the circumferential direction. Active magnetic poles, the number of which is m (m is an integer greater than or equal to two), apply magnetic fields to each ferromagnetic body from radially inside. As a result, each magnet has magnetic pole portions the number of which is m. A third gap is provided between each pair of the active magnetic poles that correspond to a common ferromagnetic body. The angular width of the third gap is set greater than a first angular width of the first gap. As a result, all magnetic pole centers are easily arranged at equal angular intervals.

### BACKGROUND OF THE INVENTION

The present invention relates to a method for manufacturing a stator. Furthermore, the present invention pertains to a magnetizing core used in the method for manufacturing the stator.

Japanese Laid-Open Patent Publication No. 2006-34089 discloses a stator of a direct-current motor. The stator includes a cylindrical yoke and magnets. The magnets are arcuate and are secured to the inner circumferential surface of the yoke. Each magnet has magnetic pole portions.

Gaps are not provided between the magnets of the above publication. In this case, it is required to increase the accuracy of the circumferential dimension of the magnets. Also, when securing the magnets to the yoke, the magnets easily collide with one another, and the magnets easily crack.

However, if gaps are provided between the magnets, it is not easy to arrange magnetic pole centers of the magnetic pole portions at equal angular intervals.

### SUMMARY OF THE INVENTION

Accordingly, it is an objective of the present invention to easily arrange all magnetic pole centers at equal angular intervals when each of magnets has a number of magnetic pole portions.

In accordance with one aspect of the present invention, a method for manufacturing a stator is provided. The manufacturing method includes securing ferromagnetic bodies, the number of which is n (n is an integer greater than or equal to two), on an inner circumferential surface of a cylindrical yoke. The ferromagnetic bodies are arcuate and extend along the inner circumferential surface. A first gap is provided between the ferromagnetic bodies that are adjacent to each other in the circumferential direction. The angular width of the first gap is referred to as a first angular width. The ferromagnetic bodies are magnetized so as to become magnets. Active magnetic poles, the number of which is m (m is an integer greater than or equal to two), apply magnetic fields to each ferromagnetic body from radially inside. As a result, each magnet has magnetic pole portions, the number of which is m. The stator has the magnetic pole portions the number of which is m×n. An active gap is provided between each pair of the active magnetic poles that correspond to a common ferromagnetic body. The angular width of the active gap is set greater than that of the first angular width.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a plan cross-sectional view illustrating a stator manufactured by a method according to one embodiment of the present invention;

FIG. 2 is a plan cross-sectional view illustrating a state where a magnetizing core is arranged inside a yoke to manufacture the stator of FIG. 1; and

FIG. 3 is a plan view of the magnetizing core shown in FIG. 2.

### DESCRIPTION OF THE PREFERRED EMBODIMENT

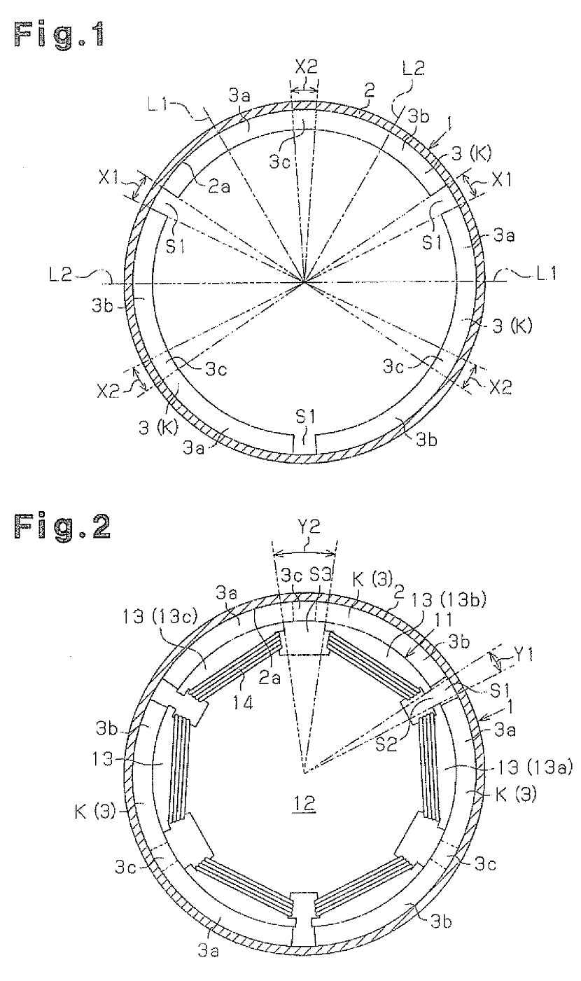

FIGS. 1 to 3 show one embodiment of the present invention.

FIG. 1 shows a stator 1 manufactured by a method according to the preferred embodiment. The stator 1 can be incorporated in a direct-current motor. The stator 1 includes a cylindrical yoke 2 and magnets 3, the number of which is n. The number n is an integer greater than or equal to two. That is, the number n is a plural number, and is three (n=3) in this embodiment. Each magnet 3 is arcuate as viewed from the axial direction of the stator 1, and is arranged (secured) along an inner circumferential surface 2a of the yoke 2. A first gap S1 is provided between each circumferentially adjacent pair of the magnets 3. In this embodiment, first angular width X1 of the first gaps S1 is set to eight degrees (X1=8°). In other words, the first angular width X1 represents the angular range of each gap between the adjacent magnets 3 in the circumferential direction.

Each magnet 3 has a first magnetic pole portion 3a and a second magnetic pole portion 3b. That is, each magnet 3 has magnetic pole portions the number of which is m. The number m is an integer greater than or equal to two, and the number m is two (m=2) in this embodiment. One of the north pole and the south pole of each first magnetic pole portion 3a is located radially outside, and the other one of the north pole and the south pole of each first magnetic pole portion 3a is located radially inside. Similarly, one of the north pole and the south pole of each second magnetic pole portion 3b is located radially outside, and the other one of the north pole and the south pole of each second magnetic pole portion 3b is located radially inside. In other words, the first magnetic pole portion 3a and the second magnetic pole portion 3b are magnetized in the radial direction. The north pole and the south pole configure a magnetic pole, which applies a magnetic field to an armature (not shown). The number of the magnetic poles of the stator 1 is six. That is, the number of the magnetic poles of the stator 1 is m×n=6. The first magnetic pole portions 3a and the second magnetic pole portions 3b are arranged such that the north poles and the south poles are alternately arranged in the circumferential direction. That is, three north poles and three south poles are alternately arrange in the circumferential direction with respect to the armature (not shown). Each first magnetic pole portion 3a has a first magnetic pole center L1 with respect to the circumferential direction, and each second magnetic pole portion 3b has a second magnetic pole center L2.

Each magnet 3 has a non-magnetic pole portion 3c. That is, the number of the non-magnetic pole portion 3c included in each magnet 3 is m−1, Each non-magnetic pole portion 3c is an intermediate portion located between the first magnetic pole portion 3a and the second magnetic pole portion 3b. The second angular width X2 of the non-magnetic pole portion 3c in the circumferential direction is set substantially equivalent to the first angular width X1 (X1≈X2). Specifically, the second angular width X2 is set such that all, the first magnetic pole centers L1 and the second magnetic pole centers L2 are arranged at equal angular intervals. Since the stator 1 has three first magnetic pole centers L1 and the second magnetic pole centers L2, the magnetic pole centers L1, L2 are arranged at intervals of 60 degrees. FIG. 1 schematically shows a boundary between the first magnetic pole portion 3a and the non-magnetic pole portion 3c and a boundary between the second magnetic pole portion 3b and the non-magnetic pole portion 3c with two-dot chain lines.

Each magnet 3 of the preferred embodiment includes two magnetic pole portions 3a, 3b. Thus, for example, as compared to a case where one magnet includes one magnetic pole portion, the number of the magnets 3 is reduced in the preferred embodiment. Also, the stator 1 has odd number of (n=3) magnets 3. The rigidity of parts of the stator 1 corresponding to (facing) the first gaps S1 is relatively weak in the stator 1 in the preferred embodiment, each first gap S1 is provided between the adjacent magnets 3. That is, the number of parts of the stator 1 where the rigidity is relatively weak is also three (odd number). Thus, vibration generated during rotation of the armature, that is, the resonance of the motor is prevented.

A method for manufacturing the stator 1 and a magnetizing core 11 used in the manufacturing method will now be described.

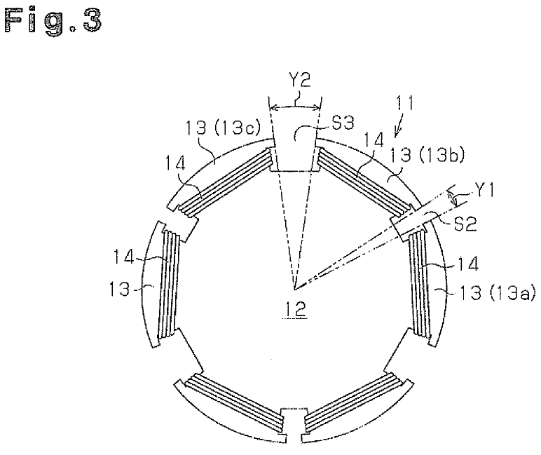

FIG. 2 shows three ferromagnetic bodies K arranged on (secured to) the stator 1. The ferromagnetic bodies K are magnetized to manufacture the magnets 3. FIGS. 2 and 3 show a magnetizing core 11 for magnetizing the ferromagnetic bodies K. FIG. 2 shows the magnetizing core 11 arranged inside the yoke 2. The magnetizing core 11 includes a substantially hexagonal column shaped base portion 12 and six projections 13. The projections 13 project radially outward from the base portion 12 in the radial pattern. The radially outer surfaces of the projections 13 are arcuate, and face the inner circumferential surfaces of the ferromagnetic bodies K. The projections 13 are close to the ferromagnetic bodies K, and gaps between the projections 13 and the ferromagnetic bodies K are slight. A coil 14 is wound around each projection 13. The magnetizing core 11 has six coils 14 in total. That is, the magnetizing core 11 has active magnetic poles the number of which is m×n (six). One of the coils 14 and the associated one of the projections 13 configure one active magnetic pole. Each active magnetic pole magnetizes one of the ferromagnetic bodies K. The magnetizing core 11 is arranged inside the yoke 2 on which the ferromagnetic bodies K are arranged. The magnetic fields (magnetic fluxes) generated by the energized coils 14 magnetize the ferromagnetic bodies K from radially inside of the ferromagnetic bodies. As a result, the first magnetic pole portions 3a and the second magnetic pole portions 3b are formed. That is, the magnets 3 are manufactured.

A second gap S2 or a third gap S3 is provided between the projections 13 that are adjacent to each other in the circumferential direction. That is, the magnetizing core 11 includes three second gaps S2 and three third gaps S3 in total. The second gaps S2 are arranged to correspond to the first gaps S1. That is, each second gap S2 is located between a pair of projections 13 that face different ferromagnetic bodies K. Also, the third gaps S3 are arranged to correspond to the non-magnetic pole portions 3c. That is, each third gap S3 is located between each pair of projections 13 that face a common ferromagnetic body K. The third gap S3 is referred to as an active gap. The second gaps S2 and the third gaps S3 are alternately arranged in the circumferential direction. The second gaps S2 are smaller than the third gaps S3. When the angular width of the second gaps S2 is referred to as a third angular width Y1, and the angular width of the third gaps S3 is referred to as a fourth angular width Y2, the third angular width Y1 is smaller than the fourth angular width Y2 (Y1<Y2). For example, assume that the projection 13 on the right of FIG. 2 is referred to as a first projection 13a, the projection 13 on the upper right of FIG. 2 is referred to as a second projection 13b, and the projection 13 on the upper left of FIG. 2 is referred to as a third projection 13c. The first projection 13a, the second projection 13b, and the third projection 13c are arranged next to one another in the circumferential direction. The second gap 52 is located between the first projection 13a and the second projection 13b. The third gap S3 is located between the second projection 13b and the third projection 13c.

More specifically, the fourth angular width Y2 is set greater than the first angular width X1, and the third angular width Y1 is set smaller than the first angular width X1 (Y1<X1<Y2) In this embodiment, Y1=6°, Y2=16°.

The method for manufacturing the stator 1 includes securing and magnetizing steps.

In the securing step, the ferromagnetic bodies K the number of which is n are arranged on (secured to) the inner circumferential surface 2a of the yoke 2. The first gaps S1 are provided between the adjacent ferromagnetic bodies K.

Then, in the magnetizing step, the magnetizing core 11 is arranged inside the yoke 2 to energize the coils 14. As a result, the ferromagnetic bodies K are magnetized, and the magnets 3 are manufactured. In each magnet 3, the fourth angular width Y2 between the first magnetic pole portion 3a and the second magnetic pole portion 3b is set greater than the first angular width X1. In this manner, the manufacture of the stator 1 is completed.

The value of the fourth angular width Y2 is set in advance in accordance with experimental results such that the second angular width X2 is substantially equivalent to the first angular width X1. Specifically, the value of the fourth angular width Y2 is obtained through experiments such that all the first magnetic pole centers L1 and the second magnetic pole centers L2 are arranged at equal angular intervals.

The preferred embodiment has the following advantages.

(1) In the securing step, the ferromagnetic bodies K the number of which is n are secured to the inner circumferential surface 2a of the yoke 2 such that the first gaps S1 are provided in between. Thus, without increasing the dimension accuracy of the ferromagnetic bodies K and the magnets 3, the ferromagnetic bodies K are prevented from colliding with one another. Thus, the ferromagnetic bodies K are easily secured to the yoke 2.

In the magnetizing step, the projections 13 the number of which is m apply magnetic fields to the ferromagnetic bodies K. The third gap S3, which is the active gap, is provided between each pair of projections 13 corresponding to a common ferromagnetic body K. The fourth angular width Y2 of the third gap S3 is greater than the first angular width X1 between the ferromagnetic bodies K.

As a comparative example, assume that the fourth angular width Y2 is equal to the first angular width X1. In this case, the second angular width X2 generated in each ferromagnetic body K after the magnetic fields are applied becomes smaller than the first angular width X1. That is, if the fourth angular width Y2 between each pair of the projections 13 that apply magnetic fields to a common ferromagnetic body K is equal to the first angular width X1, the second angular width X2 of the non-magnetic pole portions 3c will be smaller than the first angular width X1. Thus, in the comparative example, all the magnetic pole centers L1, L2 are not arranged at equal angular intervals.

In contrast, in the preferred embodiment, the fourth angular width Y2 is set greater than the first angular width X1 in advance. Thus, all the magnetic pole centers L1, L2 are set at equal angular intervals. As a result, a direct-current motor having a satisfactory property is manufactured.

(2) The fourth angular width Y2 is set greater than the first angular width X1. The fourth angular width Y2 is an angular width between each pair of projections 13 that correspond to a common ferromagnetic body K. The first angular width X1 is an angular width between the ferromagnetic bodies K. Therefore, using the magnetizing core 11 facilitates the magnetizing step, which provides the above mentioned advantage (1).

(3) The third angular width Y1 corresponds to (faces) the first angular width X1, and is set smaller than the first angular width X1. Therefore, for example, during magnetizing step, even if the magnetizing core 11 is displaced with respect to the ferromagnetic bodies K, the magnetic pole portions 3a, 3b are easily formed on the ferromagnetic bodies K to the circumferential ends.

The preferred embodiment may be modified as follows.

A jig for magnetizing the ferromagnetic bodies K need not be the magnetizing core 11 as long as each ferromagnetic body K is subjected to magnetic fields the number of which is m. The number m corresponds to the number of magnetic pole portions 3a, 3b of each magnet 3. The fourth angular width Y2 between each pair of the active magnetic poles that apply magnetic fields to a common ferromagnetic body K may be any value as long as it is greater than the first angular width X1.

Y1 need not be smaller than X1 (Y1<X1), but Y1 may be equal to X1 (Y1=X1). That is, Y1 need not be 6 degrees (Y1=6°), but may be 8 degrees (Y1=8°). Thus, the second gaps S2 need not be smaller than the first gaps S1 to which the second gaps S2 face, but may be equal to the first gaps S1. Furthermore, in other words, the third angular width Y1 between the projections 13 that face different ferromagnetic bodies K may be set equal to the first angular width X1 between the ferromagnetic bodies K.

The fourth angular width Y2 need not be 16 degrees as long as the value of the fourth angular width Y2 is determined such that all the magnetic pole centers L1, L2 are arranged at equal angular intervals. The value of the fourth angular width Y2 may be changed in accordance with the specification of the stator, for example, the specification of the first gaps S1 between the magnets 3.

The number n need not be three, but n may be any integer greater than or equal to two. Also, the number m need not be two, but m may be any integer greater than or equal to two. Thus, the number of the magnets 3 of the stator 1 need not be three, but may be any plural number. Also, the number of the magnetic pole portions 3a, 3b of each magnet 3 need not be two, but may be any plural number.

1. A method for manufacturing a stator, comprising:
securing ferromagnetic bodies (K), the number of which is n (n is an integer greater than or equal to two), on an inner circumferential surface of a cylindrical yoke, the ferromagnetic bodies are arcuate and extend along the inner circumferential surface, a first gap is provided between each circumferentially adjacent pair of the ferromagnetic bodies, and the angular width of the first gap is referred to as a first angular width; and
magnetizing the ferromagnetic bodies so that the ferromagnetic bodies become magnets, wherein active magnetic poles, the number of which is m (m is an integer greater than or equal to two), apply magnetic fields to each ferromagnetic body from radially inside, and as a result, each magnet has magnetic pole portions the number of which is m, the stator has the magnetic pole portions the number of which is m×n, an active gap is provided between each pair of the active magnetic poles that correspond to a common ferromagnetic body, and the angular width of the active gap is set greater than that of the first angular width.

2. The method according to claim 1, further comprising:
preparing a magnetizing core, the magnetizing core including projections, the number of which is m×n, arranged in a radial pattern and coils, the number of which is m×n, each coil being wound around one of the projections, and each active magnetic pole including one of the projections and one of the coils; and
arranging the magnetizing core in the yoke, the active gap being provided between each pair of the projections that correspond to a common ferromagnetic body.

3. The method according to claim 2,
wherein a second gap is provided between a pair of the projections that correspond to different ferromagnetic bodies, and
wherein the angular width of the second gap is set smaller than that of the first angular width.

4. A magnetizing core, wherein the magnetizing core is used to magnetize ferromagnetic bodies, the number of which is n (n is an integer greater than or equal to two), arranged on an inner circumferential surface of a cylindrical yoke from radially inside of the ferromagnetic bodies so as to turn the ferromagnetic bodies into magnets, each magnet including magnetic pole portions, the number of which is m (m is an integer greater than or equal to two), the ferromagnetic bodies are arcuate and are arranged in the circumferential direction with first gaps provided in between, the angular width of the first gaps is referred to as a first angular width, the magnetizing core comprising:
projections, the number of which is m×n, arranged in a radial pattern, an active gap is provided between each pair of the projections that correspond to a common ferromagnetic body, and the angular width of the active gap is set greater than that of the first angular width; and
coils, the number of which is m×n, each coil being wound around one of the projections.

5. The magnetizing core according to claim 4,
wherein a second gap is provided between a pair of the projections that correspond to different ferromagnetic bodies, and the angular width of the second gap is set smaller than that of the first angular width.

6. A magnetizing core, comprising:
a plurality of projections arranged in a radial pattern, the projections including a first projection, a second projection, and a third projection, which are arranged next to one another in the circumferential direction, and a gap between the first projection and the second projection is smaller than a gap between the second projection and the third projection; and
a plurality of coils, each coil being wound around one of the projections.
